(19) United States
(12) Patent Application Publication
(10) Pub. No.: US 2007/0163694 A1
(43) Pub. Date: Jul. 19, 2007

(54) Pneumatic tire

(76) Inventor: Takayuki Suzuki, Kanagawa (JP)

Correspondence Address: GREER, BURNS & CRAIN, 300 S WACKER DR, 25TH FLOOR, CHICAGO, IL, 60606, US

(21) Appl. No.: 10/589,798

(22) PCT Filed: Dec. 26, 2005
(86) PCT No.: PCT/JP05/23823

§ 371 Date: Aug. 17, 2006

(30) Foreign Application Priority Data
Dec. 27, 2004 (JP) 2004-377644

(51) Int. Cl. B60C 11/13; B60C 11/00

(52) U.S. Cl. 152/209.18; 152/209.19

(57) ABSTRACT

A pneumatic tire includes a plurality of grooves formed on a tread portion and a plurality of blocks divided by the grooves. A ratio of a block facing length c to a width b of the groove c/b is in a range of 0.50≦c/b≦1.30, where the block facing length c is a length of a shorter line segment obtained by selecting a pair of blocks adjacent to each other across a groove, drawing perpendicular lines from two vertices of one block on a side of a sandwiched groove to other block, respectively, connecting ends of the perpendicular lines by a line segment along an outer circumference of the block, and comparing a length of the line segment between the blocks.

### TECHNICAL FIELD

The present invention relates to a pneumatic tire, and more particularly, to a pneumatic tire capable of improving groove-crack resistance of a tire while maintaining a traction of the tire on a snowy road or a wear resistance of the tire on an unpaved road.

### BACKGROUND ART

In pneumatic tires for heavy loads used for a vehicle to drive on unpaved roads or snowy roads, there is a problem that foreign objects such as stones are trapped in grooves when the vehicle is traveling, and these foreign objects cause groove cracks, which leads to a damage to a belt portion.

Referring to the problem, there is known a technology for a conventional pneumatic tire described in Patent document 1. The conventional pneumatic tire includes a casing that forms a body of a tire, and a tread arranged on the outer side of the crown portion of the casing in its radial direction. Formed on the tread are grooves extending in a circumferential direction and/or in a direction inclined to the circumferential direction.

(1) At least one sidewall of a part of or of all grooves formed on the tread is formed with three regions such as an outside steep-slope region, a middle gentle-slope region, and an inside steep-slope region, which are consecutively formed. The outside steep-slope region is a region which ranges from a tread surface to a depth A equivalent to 25% to 45% of a depth D and in which a groove-sidewall angle α is 0 degrees to 8 degrees. The middle gentle-slope region is a region which ranges from the depth A of the outside steep-slope region to a depth B equivalent to 65% to 80% of the depth D and in which a groove-sidewall angle β is 15 degrees or more. The inside steep-slope region is a region which ranges from the depth B of the middle gentle-slope region to a depth of a groove bottom equivalent to 100% of the depth D and in which a groove-sidewall angle γ is 0 degrees to 8 degrees. Further, (2) Stone ejectors are arranged in a zigzag form or substantially zigzag form in a direction in which the grooves extend. The stone ejector is a button shaped one which is protruded from the groove bottom, by only a height C equivalent to 10% to 20% of the depth D, of a groove with at least one sidewall which is formed in the three regions, and which is inwardly protruded from either one of groove sidewalls on both sides by only a width w equivalent to 25% to 50% of a width W.

The conventional pneumatic tire is structured in the above manner to prevent groove cracks from being suppressed by reducing drilling of foreign objects in grooves.

Patent document 1: Japanese Patent Application Laid-Open No. H11-129707

### DISCLOSURE OF INVENTION

### Problem to be Solved by the Invention

It is an object of the present invention to provide a pneumatic tire capable of improving the groove-crack resistance of a tire while the traction of the tire on snowy roads or its wear resistance on unpaved roads is maintained.

### Means for Solving Problem

To achieve the above object, a pneumatic tire according to an embodiment of the present invention includes a plurality of grooves formed on a tread portion; and a plurality of blocks divided by the grooves. A ratio of a block facing length c to a width b of the groove c/b is in a range of 0.50≦c/b≦1.30, where the block facing length c is a length of a shorter line segment obtained by selecting a pair of blocks adjacent to each other across a groove from a plan view of the tread portion, drawing perpendicular lines from two vertices of one block on a side of a sandwiched groove to other block across the sandwiched groove, respectively, connecting ends of the perpendicular lines by a line segment along an outer circumference of the block, and comparing a length of the line segment between the blocks.

In the pneumatic tire according to the present invention, the block facing length c and the width b of a groove are defined so as to satisfy a predetermined relationship. This offers an advantage that foreign-object drilling in grooves is reduced to allow suppression of groove-crack occurrence. This also offers another advantage that the wear resistance of the tire on unpaved roads is maintained.

In the pneumatic tire according to the present invention, the ratio of the block facing length c to the width b of the groove c/b is in a range of 1.00≦c/b.

With the pneumatic tire according to the present invention, the ratio c/b between the block facing length c and the width b of the groove is made appropriate, and this offers an advantage that groove-crack occurrence is more effectively suppressed. This also offers another advantage that the wear resistance of the tire on unpaved roads is more adequately maintained.

In the pneumatic tire according to the present invention, a ratio of the block facing length c to a depth a of the groove c/a is in a range of 0.40≦c/a≦0.85.

With the pneumatic tire according to the present invention, the ratio c/a between the block facing length c and the depth a of the groove is defined so as to satisfy a that foreign-object drilling in grooves is reduced and groove-crack occurrence is suppressed. This also offers another advantage that the traction of the tire on snowy roads is maintained and its wear resistance on unpaved roads is also maintained.

A pneumatic tire according to another aspect of the present invention includes a plurality of grooves formed on a tread portion; and a plurality of blocks divided by the grooves. A ratio of a block facing length c to a depth a of the groove c/a is in a range of 0.40≦c/a≦0.85, where the block facing length c is a length of a shorter line segment obtained by selecting a pair of blocks adjacent to each other across a groove from a plan view of the tread portion, drawing perpendicular lines from two vertices of one block on a side of a sandwiched groove to other block across the sandwiched groove, respectively, connecting ends of the perpendicular lines by a line segment along an outer circumference of the block, and comparing a length of the line segment between the blocks.

With the pneumatic tire according to the present invention, the block facing length c and the width b of a groove are defined so as to satisfy a predetermined relationship. This offers an advantage that foreign-object drilling in grooves is reduced to allow suppression of groove-crack occurrence. This also offers another advantage that the traction of the tire on snowy roads is maintained.

In the pneumatic tire according to the present invention, the ratio of the block facing length c to the depth a of the groove c/a is in a range of 0.60≦c/a≦0.80.

With the pneumatic tire according to the present invention, the ratio c/a between the block facing length c and the depth a of the groove is made appropriate, and this offers an advantage that the foreign-object drilling in grooves is further reduced and the groove-crack occurrence is further suppressed.

The pneumatic tire according to the present invention further includes at least three lines of a block array formed with a plurality of the blocks arranged in a tire circumferential direction.

With the pneumatic tire according to the present invention, the block facing length c related to adjacent block arrays, and the depth a and the width b of the groove are defined so as to have a predetermined relationship, and this offers an advantage that the foreign-object drilling in grooves is further reduced and the groove-crack occurrence is more effectively suppressed. This also offers another advantage that the traction of the tire on snowy roads and its wear resistance on unpaved roads are adequately maintained.

In the pneumatic tire according to the present invention, the groove includes an inclined groove that is inclined with respect to a tire circumferential direction, and a substantially net-shaped tread pattern is formed on the tread portion.

With the pneumatic tire according to the present invention, the tread portion has the net-shaped block pattern formed with the inclined grooves. This offers an advantage that the wear resistance on unpaved roads and the traction on snowy roads are compatible to improve the running performance on both the unpaved roads and the snowy roads.

In the pneumatic tire according to the present invention, an angle of inclination of the inclined groove is in a range between 30 degrees and 60 degrees.

With the pneumatic tire according to the present invention, the angle of inclination of the inclined groove is in the predetermined range. This offers an advantage that foreign-object drilling in grooves is further reduced.

In the pneumatic tire according to the present invention, a ratio of the depth a and the width b of the groove b/a is in a range of 0.6≦b/a≦0.8.

With the pneumatic tire according to the present invention, the ratio b/a between the depth a and the width b of the groove is in the predetermined range. This offers an advantage that foreign-object drilling in main grooves is further reduced.

In the pneumatic tire according to the present invention, a protrusion for suppressing a foreign-object drilling is formed in a bottom of the groove.

With the pneumatic tire according to the present invention, the protrusion is formed in the groove bottom, and this offers an advantage that foreign-object drilling in grooves is more effectively suppressed.

### EFFECT OF THE INVENTION

In the pneumatic tire according to the present invention, the block facing length c and the width b of a groove are defined so as to satisfy a predetermined relationship. This offers an advantage that foreign-object drilling in grooves is reduced to allow suppression of groove-crack occurrence.

### BRIEF DESCRIPTION OF DRAWINGS

FIG. 1 is a plan view of a tread portion of a pneumatic tire according to an embodiment of the present invention;

FIG. 2 is a cross-section of a groove of the pneumatic tire according to the present embodiment;

FIG. 3 is a schematic of the pneumatic tire according to the present embodiment;

FIG. 4 is a schematic of a modification of the pneumatic tire shown in FIG. 1;

FIG. 5 is a diagram of test results indicating performance tests of the pneumatic tire according to the present embodiment;

FIG. 6 is a diagram of test results indicating performance tests of the pneumatic tire according to the present embodiment; and

FIG. 7 is a diagram of test results indicating performance tests of the pneumatic tire according to the present embodiment.

### EXPLANATIONS OF LETTERS OR NUMERALS

1 Pneumatic tire

2 Main groove

3 Lateral groove

4 Block

4 First center block

5 Second center block

6 Shoulder block

7 Protrusion

### BEST MODE(S) FOR CARRYING OUT THE INVENTION

Exemplary embodiments of the present invention are explained in detail below with reference to the accompanying drawings. It is noted that the present invention is not limited by these embodiments. It is also noted that components of the embodiments include those which can easily be replaced by persons skilled in the art or those substantially equivalent thereto. Moreover, a plurality of modifications described in the embodiments can be arbitrarily combined within the scope obvious to persons skilled in the art.

### EMBODIMENTS

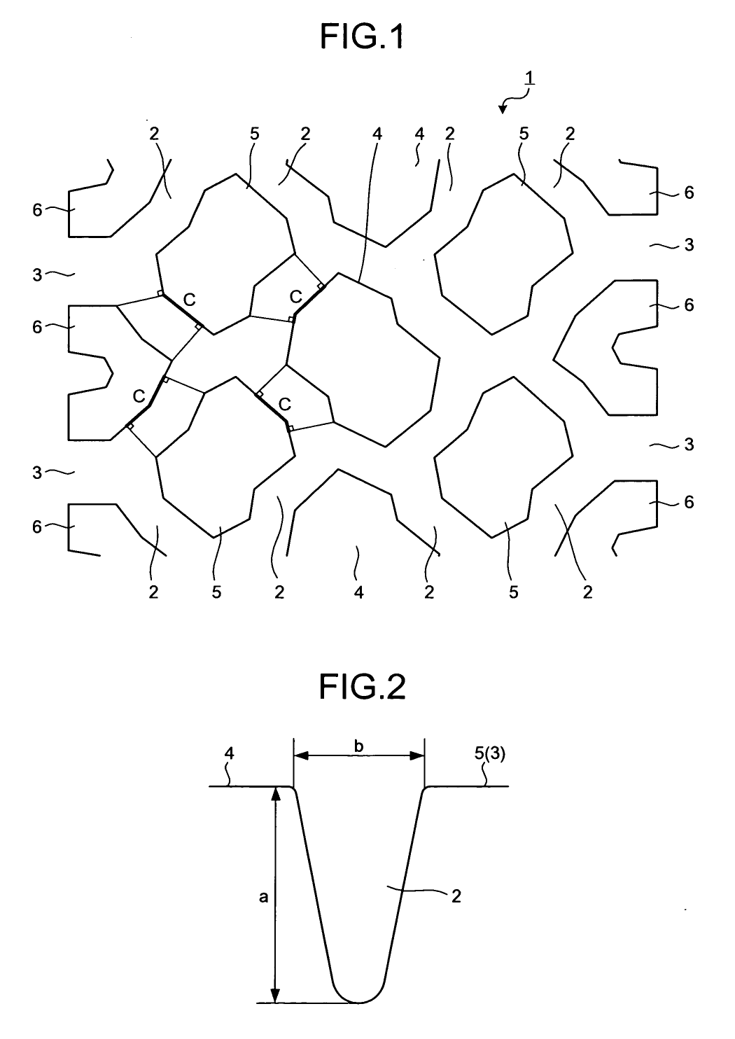

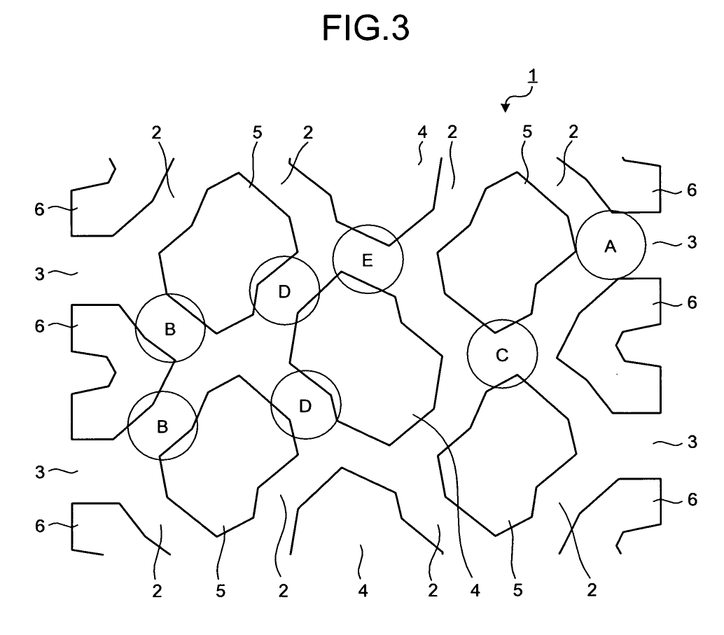

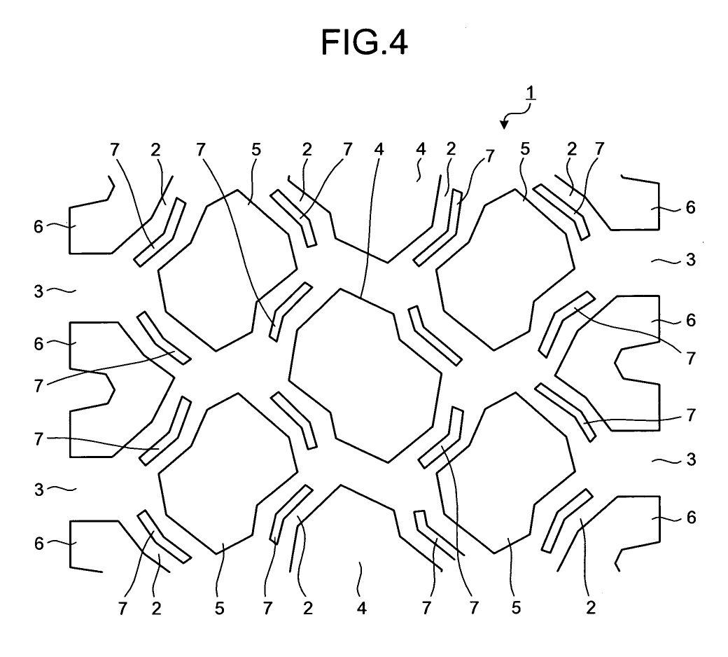

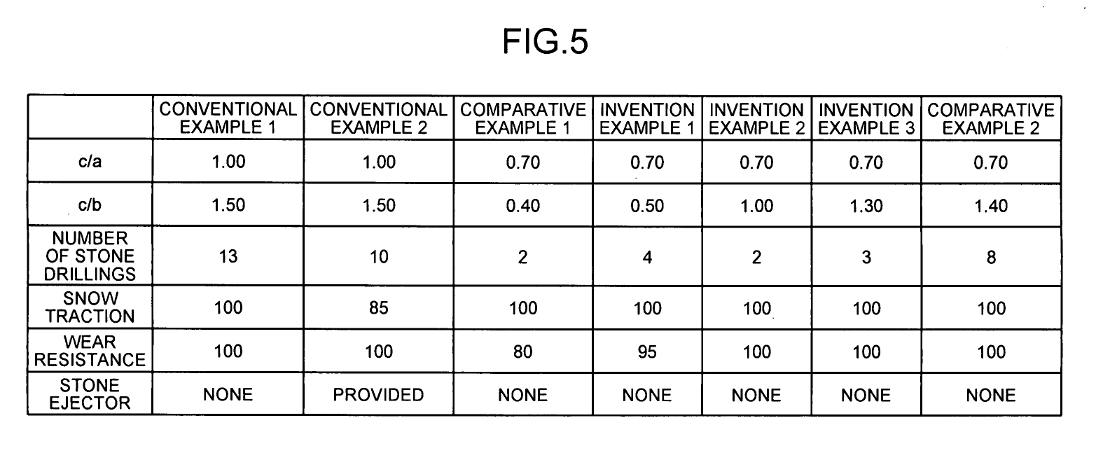

FIGS. 1 to 3 are plan views of a tread portion of the pneumatic tire according to an embodiment of the present invention (FIG. 1), a cross-section of a groove (FIG. 2), and a schematic of grooves (FIG. 3). FIG. 4 is a schematic of a modification of the pneumatic tire shown in FIG. 1. FIGS. 5 to 7 are diagrams of test results indicating performance tests of the pneumatic tire according to the present embodiment.

A pneumatic tire 1 includes a plurality of grooves 2 and 3 formed on the tread portion, and blocks 4 to 6 into which the tread portion is divided by these grooves 2 and 3. The grooves 2 and 3 are formed with a main groove 2 and a lateral groove 3. The main groove 2 is an inclined groove (see FIG. 1) that is inclined to a tire circumferential direction or a vertical groove extending along the tire circumferential direction. The lateral groove 3 is a lug groove that intersects, for example, the main groove 2. Formed on the tread portion are a plurality (five lines) of block arrays which are formed with these main grooves 2 and lateral grooves 3 and which extend along the tire circumferential direction.

The blocks 4 to 6 include a first center block 4, a second center block 5, and a shoulder block 6. At first, a plurality of first center blocks 4 are arranged along a tire equator which extends along the tire circumferential direction, and one block array is formed with these first center blocks 4. A plurality of second center blocks 5 are arranged along the tire circumferential direction on both sides of the block array formed with the first center blocks 4. That is, each block array is formed with these second center blocks and is arranged along each of the both sides. A plurality of shoulder blocks 6 are arranged on both edge portions of the tread portion along the tire circumferential direction. That is, each block array is formed with these shoulder blocks 6 and is arranged along each of the both edge portions.

According to the present embodiment, the main grooves 2 are formed with inclined grooves, thus, forming a net-shaped tread pattern on the tread portion. If each arrangement of the blocks 4 to 6 is viewed from a direction inclined to the tire circumferential direction, the first center block 4 is located at the center of the tread portion, the second center blocks 5 and 5 as a pair are located on both sides of the first center block 4, and the shoulder blocks 6 and 6 as a pair are located outside the second center blocks 5 and 5, respectively. These blocks are arranged in each row in the direction inclined to the tire circumferential direction.

Here, the length as follows is called “block facing length c”. At first, select a pair of blocks which face each other across a groove, based on plan view of the tread portion. Then, two perpendicular lines are drawn from two vertices of one block having vertices to the other block (side), the two vertices being located on the groove side, of the one block, which is opposite to the other block. Next, the feet of the two perpendicular lines are connected with a line segment along an outer circumference of the other block. The line segment can be drawn for each block. The lengths of line segments are compared with each other between the pair of blocks, and the length of a shorter line segment is set as the block facing length c.

In the pneumatic tire 1, the block facing length c, and the depth a and the width b of the main groove 2 are defined between blocks (groove portion) where foreign objects may easily become lodged. For example, a location in which a foreign object may easily be lodged corresponds to a gap between blocks which form an adjacent pair but belong to mutually different block arrays. More specifically, (1) a gap D between the first center block 4 and the second center block 5 and (2) a gap B between the second center block 5 and the shoulder block 6 are where foreign objects may easily become lodged (see FIG. 3). However, the same structure may also be adopted by gaps A, C, and E between each pair of blocks which belong to the same block array, respectively.

The block facing length c, and the depth a and the width b of the main groove 2 are defined, for example, in the following manner. That is, a ratio between the block facing length c and the depth a of the main groove 2 is in a range of 0.40≦c/a≦0.85, and a ratio c/b between each block facing length c of the blocks 4 to 6 and the width b of the main groove 2 is in a range of 0.50≦c/b≦1.30. The depth a and the width b of the main groove 2 are related to a range where the block facing length c extends.

[Operation and Effect]

With the above structure, each block facing length c of the blocks 4 to 6, and the depth a or the width b of the main groove 2 are defined so as to satisfy a predetermined relationship therebetween. Therefore, foreign-object drilling in the main groove 2 (between blocks) is reduced. This offers an advantage that groove-crack occurrence can be effectively suppressed. Even with this structure, there is another advantage that the wear resistance on unpaved roads is maintained and the traction on snowy roads is also maintained.

More specifically, each block facing length c of the blocks 4 to 6, and the depth a and the width b of the main groove 2 contribute to (1) anti-stone drilling (groove-crack resistance), (2) traction on snowy roads, and (3) wear resistance on unpaved roads (durability against irregular wear affected to tire life), as follows.

At first, in the relationship between each block facing length c of the blocks 4 to 6 and the width b of the main groove 2, there is an tendency such that a decrease in the ratio c/b allows improvement in the anti-stone drilling of the tire (1). For example, if each block facing length c of the blocks 4 to 6 is shorter, a space where stones are retained is made less. But, if the width b of the main groove 2 is wider, the stones retained in the main grooves 2 are more easily ejected. Conversely, if the width b of the main groove 2 is narrower, the blocks 4 to 6 become larger, which causes drilling force of the blocks 4 to 6, when stones are retained, to increase, this leads to reduction in the anti-stone drilling of the tire. Further, an increase of the ratio c/b allows improvement in the wear resistance of the tire on unpaved roads (2). For example, if the width b of the main groove 2 is narrower, each area of the blocks 4 to 6 (ground contact area) increases, which causes a ground contact pressure per unit area to decrease. As a result, the tire is not easily worn. However, the ratio c/b does not much contribute to the traction of the tire on snowy roads (3). Therefore, according to (1), (2), and (3) as mentioned above, the ratio c/b between each block facing length c of the blocks 4 to 6 and the width b of the main groove 2 is made appropriate, and this offers an advantage that the groove-crack resistance can be improved while the wear resistance of the tire on unpaved roads is maintained.

In the relationship between each block facing length c of the blocks 4 to 6 and the depth a of the main groove 2, (1) there is an tendency such that a decrease in a ratio c/a allows improvement in the anti-stone drilling of the tire. For example, if each block facing length c of the blocks 4 to 6 is shorter, a space where stones are retained is made less. (2) The ratio c/a less contributes to the wear resistance of the tire on unpaved roads. However, the increase of the depth a of the main groove 2 allows the influence due to wear to be released, this makes tire life prolonged. (3) The increase of the ratio c/a allows improvement in the traction of the tire on snowy roads. For example, if each block facing length c of the blocks 4 to 6 increases, then each edge component of the blocks 4 to 6 is increased. This allows snow-column shear strength of the blocks 4 to 6 to increase. Therefore, according to (1) to (3) as mentioned above, the ratio c/a between each block facing length c of the blocks 4 to 6 and the depth a of the main groove 2 is made appropriate, and this offers an advantage that the groove-crack resistance can be improved while the traction of the tire on snowy roads is maintained.

Therefore, the ratio c/b and the ratio c/a are preferably selected as required within a range which is obvious to persons skilled in the art based on the above explanation. It is noted that each block facing length c of the blocks 4 to 6 is generally dependent on a block pattern of a tire, and hence, tire manufacturers can comparatively freely adjust the length. On the other hand, the depth a and the width b of the main groove 2 are defined according to specifications and categories or the like of tires, and hence, there is less room to adjust them. Therefore, when the specifications and the categories of tires are limited, the block pattern is changed to adjust each block facing length c of the blocks 4 to 6, and the ratio c/b and the ratio c/a are thereby made most appropriate.

[First Modification]

In the pneumatic tire 1, the ratio c/a between each block facing length c of the blocks 4 to 6 and the depth a of the main groove 2 is in the range of 0.40≦c/a≦0.85, but it is preferable that the ratio c/a be in a range of 0.6≦c/a≦0.8. This offers an advantage that groove-crack occurrence can be more effectively suppressed and the traction performance on snowy roads is adequately maintained. Moreover, irregular wear resistance on unpaved roads is maintained.

[Second Modification]

In the pneumatic tire 1, the ratio c/b between each block facing length c of the blocks 4 to 6 and the width b of the main groove 2 is in the range of 0.50≦c/b≦1.30, but it is preferable that the ratio c/b be in a range of 1.00≦c/b≦1.30. This offers an advantage that groove-crack occurrence is more effectively suppressed and the irregular wear resistance on unpaved roads is adequately maintained. Moreover, the traction performance on snowy roads is maintained.

[Third Modification]

In the pneumatic tire 1, the main grooves 2 are formed with inclined grooves which are inclined with respect to the tire circumferential direction, to form a net-shaped tread pattern (see FIG. 1). This structure allows compatibility between the wear resistance on unpaved roads and the traction on snowy roads. Therefore, it is desirable in improvement of running performance on both unpaved roads and snowy roads. However, the structure is not limited to this, and therefore, the main groove 2 may be a vertical groove extending along the tire circumferential direction.

Furthermore, based on this structure, an angle of inclination of the main groove 2 (inclined groove) with respect to the tire circumferential direction is preferably in a range of 30 degrees or more and 60 degrees or less. Such a structure as above offers an advantage that foreign-object drilling in the main grooves 2 is further reduced. Moreover, there is another advantage that the wear resistance on unpaved roads and the traction on snowy roads are compatible with each other to improve running performance on both unpaved roads and snowy roads.

Based on this structure, a ratio b/a between the depth a and the width b of the main groove 2 is preferably in a range of 0.6≦S/a≦0.8, and more preferably in a range of 0.6≦/a≦0.7. This offers an advantage that the running performance on both unpaved roads and snowy roads is further improved. Moreover, such a structure as above also offers another advantage that foreign-object drilling in the main grooves 2 is further reduced.

For example, if 0.8≦b/a, the width b of the main groove 2 increases and each area of the blocks 4 to 6 decreases when the depth a of the main groove 2 is fixed according to specifications and so forth of a tire. This causes the ground contact area of the tire to decrease, and the tire is thereby easily worn. Therefore, wear resistance of the tire on unpaved roads is reduced. If b/a<0.6, the cross section of the main groove 2 becomes acute in the direction of the depth. Then, stones lodged in the main grooves 2 are not easily ejected therefrom, which causes anti-stone drilling of the tire to be reduced. Furthermore, the main groove 2 is easily cracked, which causes the wear resistance (durability) of the tire on unpaved roads to decrease. Moreover, when the depth a of the main groove 2 is fixed, the width b of the main groove 2 is made narrow. This causes drainage of the main groove 2 to decrease, which leads to reduction in running performance of the tire on both unpaved roads and snowy roads.

It is known that in the pneumatic tires for heavy loads, the ratio b/a between the depth a and the width b of the main groove 2 is made appropriate to the range (0.623 /a≦0.8), to improve (maintain) the wear resistance of the tire on unpaved roads and the running performance of the tire on both unpaved roads and snowy roads. Here, the ratio c/a and the ratio c/b are made appropriate to the ranges (0.40≦c/a≦0.85 and 0.50≦c/b≦1.30) respectively, and the ratio b/a is made appropriate to the range. The appropriate ratios are therefore effective in points that the anti-stone drilling of tires is improved and various functions required for tires (traction on snowy roads, wear resistance on unpaved roads, running performance, etc.) are maintained.

[Fourth Modification]

Some of conventional pneumatic tires have protrusions (stone ejectors) provided in the groove bottom of the main groove to suppress foreign-object drilling in the main groove. In such a structure as above, however, the protrusions cause the cross-sectional area of the main grooves to be reduced, and this causes the traction performance on snowy roads to decrease. Referring to this point, the pneumatic tire 1 is desirable in prevention of foreign objects from becoming lodged in the grooves without these protrusions.

However, the structure is not limited to this, and therefore, a protrusion 7 may be formed in the groove bottom of the main groove 2 (see FIG. 4). This offers an advantage that foreign-object drilling is more effectively suppressed. In such a structure, it is preferable that the protrusion 7 be formed at a location in which a foreign object may easily become lodged. This location corresponds to the gaps B and D between blocks, which belong to mutually different block arrays but are formed as an adjacent pair (see FIG. 3). This also offers another advantage that the foreign-object drilling is further effectively suppressed.

In the pneumatic tire 1, because the foreign-object drilling is suppressed without the protrusion 7, even if a small protrusion 7 is formed, sufficient effect is obtained. This offers an advantage that the anti-foreign-object drilling and the traction performance on snowy roads can be compatible.

[Application Example]

The problem about the foreign-object drilling in the heavy-duty pneumatic tires is serious, and it is strongly requested that the pneumatic tires have the improved irregular wear resistance on unpaved roads and traction performance on snowy roads. Therefore, the structure of the pneumatic tire 1 is preferably applied to the heavy-duty pneumatic tires. This allows more useful effect to be obtained.

[Performance Test]

In the embodiment, performance tests were conducted on a plurality of pneumatic tires under different conditions. Test items were (1) anti-stone drilling (groove-crack resistance), (2) traction on snowy roads (snow traction), and (3) wear resistance on unpaved roads (see FIG. 5 to FIG. 7). In the performance tests, the pneumatic tire having a tire size of 11R22.5 was assembled to a normal rim defined by JATMA, and a normal load and a normal pneumatic pressure were applied to the pneumatic tire. And the pneumatic tire was attached to the drive shaft of a 2-D (two-wheel drive dual rear wheel) vehicle.

(1) In the performance tests on the groove-crack resistance, a test vehicle runs along an unpaved road of 10 [km] at a speed of 10 [km/h] to 30 [km/h], and the number of stones lodged per tire is measured. (2) In the performance tests on the traction on snowy roads, acceleration on a compacted-snow covered slope is evaluated using an index based on how special panelists feel about it. The index value is preferably larger. (3) In the performance test on wear resistance on unpaved roads, a test vehicle runs along a test course with 80% of paved road and 20% of unpaved road, and a running distance is measured when any one of block heights (depth) becomes 5 mm. Then the evaluation is made with the index based on the result of measurement. The index value is preferably larger. If the index value is within ±5, it is determined that the performance at an equivalent level is delivered.

In pneumatic tires 1 according to invention examples 1 to 11, the ratio between the block facing length c and the depth a of the main groove 2 is in the range of 0.40≦c/a≦0.85, and the ratio c/b between the block facing length c and the width b of the main groove 2 is in the range of 0.50≦c/b≦1.30. Furthermore, in these pneumatic tires 1, the stone ejectors (protrusions 7) are not formed in the groove bottom.

In pneumatic tires according to conventional examples 1 and 2, the block facing length c, and the depth a and the width b of the main groove 2 have no relationship as explained above. The pneumatic tire according to the conventional example 1 has the stone ejector while the pneumatic tire according to the conventional example 2 has no stone ejector. In pneumatic tires according to comparative examples 1 to 4, the block facing length c, and the depth a and the width b of the main groove 2 have no relationship explained above. These pneumatic tires do not have the stone ejectors.

As shown in the test results, the block facing length c, and the depth a and the width b of the main groove 2 are defined so as to satisfy a predetermined relationship, and it is thereby found that the groove-crack resistance is improved. It is also found that the traction on snowy roads and the wear resistance on unpaved roads are maintained in the same manner as that of the conventional examples.

The invention examples 1 to 11 are compared with, for example, the conventional examples 1 and 2, to find that anti-stone drilling of the tires is significantly improved (see FIG. 5 to FIG. 7).

The invention examples 1 to 3 are compared with the comparative examples 1 and 2, to find that the ratio c/b between the block facing length c and the width b of the main groove 2 is set in the predetermined range (0.50≦c/b≦1.30) and this setting allows the wear resistance of the tires on unpaved roads (and the traction on snowy roads) to be maintained and also allows improved groove-crack resistance of the tires (see FIG. 5). Furthermore, it is found that by making the ratio c/b appropriate (1.00≦c/b), the wear resistance of the tires on unpaved roads is more adequately maintained.

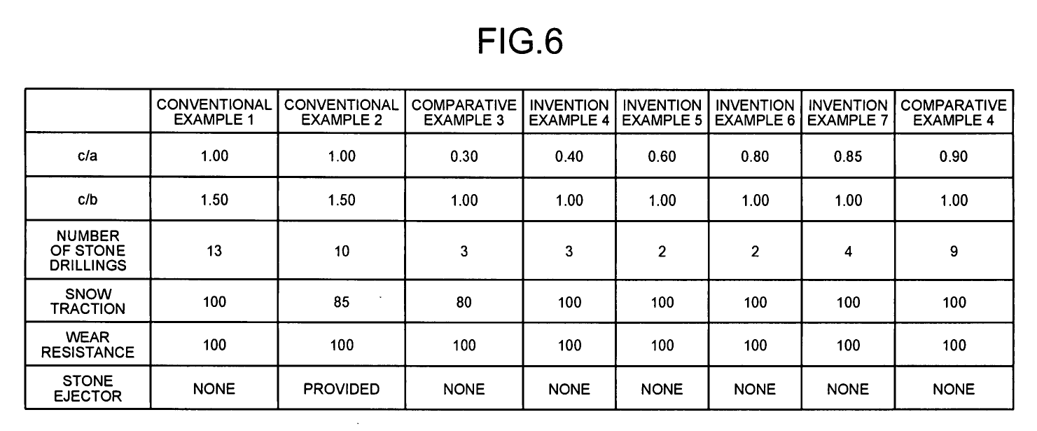

The invention examples 4 to 7 are compared with the comparative examples 3 and 4, to find that the ratio c/a between the block facing length c and the depth a of the main groove 2 is set in the predetermined range (0.40≦c/a≦0.85) and this allows the traction of the tires on snowy roads (and the wear resistance on unpaved roads) to be maintained, and also allows improved groove-crack resistance of the tires (see FIG. 6). Furthermore, it is found that by making the ratio c/a appropriate (0.60≦c/a≦0.80), the groove-crack resistance of the tires is further improved.

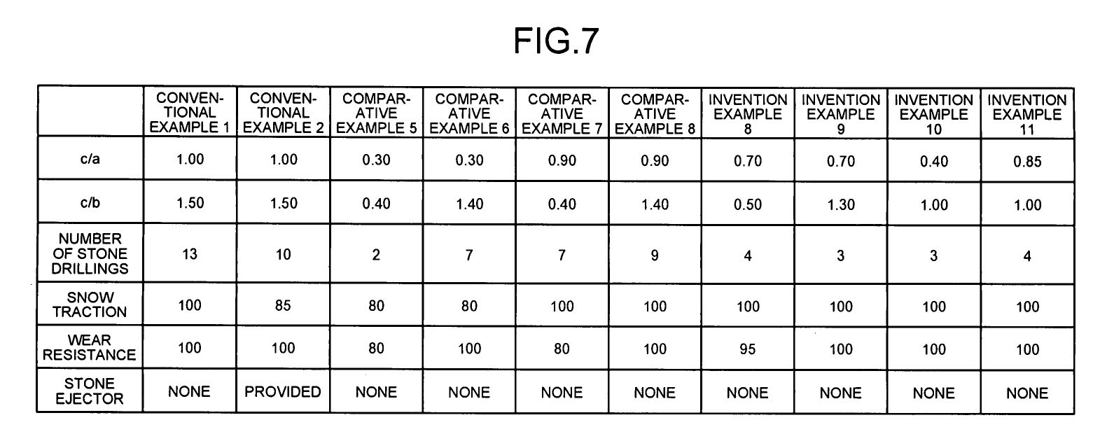

The invention examples 8 to 11 are compared with comparative examples 5 to 8, to find that both the ratio c/b and the ratio c/a are set in the respective ranges and this allows the groove-crack resistance of the tires to be improved, and also allows the maintenance of the traction performance on snowy roads and maintenance of the wear resistance on unpaved roads to be compatible (see FIG. 7).

As explained above, in the pneumatic tires for heavy loads, it is known that the ratio b/a between the depth a and the width b of the main groove 2 is set in the predetermined range (0.6≦b/a≦0.8) to thereby improve (maintain) the wear resistance of tires on unpaved roads and the running performance on snowy roads. As for this point, the invention examples 5 to 7 (b/a=0.60, 0.70, 0.80 in this order) are referred to. By setting the ratio b/a in the above range, it is found that the anti-stone drilling of tires is also improved while the traction of tires on snowy roads and the wear resistance thereof on unpaved roads are maintained.

### INDUSTRIAL APPLICABILITY

As can be seen, the pneumatic tire according to the present invention is useful in improving the groove-crack resistance of tires while the traction performance of tires on snowy roads or the wear resistance thereof on unpaved roads is maintained.

1-10. (canceled)

11. A pneumatic tire comprising:
a plurality of grooves formed on a tread portion; and
a plurality of blocks divided by the grooves, wherein
a ratio of a block facing length c to a width b of the groove c/b is in a range of 0.50≦c/b≦1.30, where the block facing length c is a length of a shorter line segment obtained by selecting a pair of blocks adjacent to each other across a groove from a plan view of the tread portion, drawing perpendicular lines from two vertices of one block on a side of a sandwiched groove to other block across the sandwiched groove, respectively, connecting ends of the perpendicular lines by a line segment along an outer circumference of the block, and comparing a length of the line segment between the blocks.

12. The pneumatic tire according to claim 11, wherein
the ratio of the block facing length c to the width b of the groove c/b is in a range of 1.00≦c/b≦1.30.

13. The pneumatic tire according to claim 11, wherein
a ratio of the block facing length c to a depth a of the groove c/a is in a range of 0.40≦c/a≦0.85.

14. The pneumatic tire according to claim 13, wherein
the ratio of the block facing length c to the depth a of the groove c/a is in a range of 0.60≦c/a≦0.80.

15. The pneumatic tire according to claim 11, further comprising:
at least three lines of a block array formed with a plurality of the blocks arranged in a tire circumferential direction.

16. The pneumatic tire according to claim 11, wherein
the groove includes an inclined groove that is inclined with respect to a tire circumferential direction, and
a substantially net-shaped tread pattern is formed on the tread portion.

17. The pneumatic tire according to claim 16, wherein
an angle of inclination of the inclined groove is in a range between 30 degrees and 60 degrees.

18. The pneumatic tire according to claim 11, wherein
a ratio of a depth a and the width b of the groove b/a is in a range of 0.6≦b/a≦0.8.

19. The pneumatic tire according to claim 11, wherein
a protrusion for suppressing a foreign-object drilling is formed in a bottom of the groove.

20. A pneumatic tire comprising:
a plurality of grooves formed on a tread portion; and
a plurality of blocks divided by the grooves, wherein
a ratio of a block facing length c to a depth a of the groove c/a is in a range of 0.40≦c/a≦0.85, where the block facing length c is a length of a shorter line segment obtained by selecting a pair of blocks adjacent to each other across a groove from a plan view of the tread portion, drawing perpendicular lines from two vertices of one block on a side of a sandwiched groove to other block across the sandwiched groove, respectively, connecting ends of the perpendicular lines by a line segment along an outer circumference of the block, and comparing a length of the line segment between the blocks.

21. The pneumatic tire according to claim 20, wherein
the ratio of the block facing length c to the depth a of the groove c/a is in a range of 0.60≦c/a≦0.80.

22. The pneumatic tire according to claim 20, further comprising:
at least three lines of a block array formed with a plurality of the blocks arranged in a tire circumferential direction.

23. The pneumatic tire according to claim 20, wherein
the groove includes an inclined groove that is inclined with respect to a tire circumferential direction, and
a substantially net-shaped tread pattern is formed on the tread portion.

24. The pneumatic tire according to claim 23, wherein
an angle of inclination of the inclined groove is in a range between 30 degrees and 60 degrees.

25. The pneumatic tire according to claim 20, wherein
a ratio of the depth a and a width b of the groove b/a is in a range of 0.6≦b/a≦0.8.

26. The pneumatic tire according to claim 20, wherein
a protrusion for suppressing a foreign-object drilling is formed in a bottom of the groove.
